(19) United States
(12) Patent Application Publication
(10) Pub. No.: US 2018/0260307 A1
(43) Pub. Date: Sep. 13, 2018

(54) METHOD AND SYSTEM FOR DETERMINING EFFORT FOR PERFORMING SOFTWARE TESTING

(71) Applicant: Wipro Limited, Bangalore (IN)

(72) Inventors: Shikha VARSHNEY, Bangalore (IN); Rupali AGARWAL, Mumbai (IN); Aditya TANWAR, Bangalore (IN); Ganesh NARAYAN, Bangalore (IN)

(73) Assignee: Wipro Limited

(21) Appl. No.: 15/463,649

(22) Filed: Mar. 20, 2017

(30) Foreign Application Priority Data
Mar. 7, 2017 (IN) 201741007895

(51) Int. Cl. G06F 11/36; G06F 9/44

(52) U.S. Cl. CPC G06F 11/3668; G06F 8/77

(57) ABSTRACT

The method and system of present disclosure relate to software testing. In an embodiment the method includes receiving historical effort data and project complexity data associated with plurality of projects. Further, normalization factors corresponding to the plurality of projects are computed based on sizes of the plurality of projects. Also, a set of user ratings corresponding to a set of predefined parameters are collected for computing a set of weightages for the plurality of projects. Finally, based on the weightages, one or more complexity scale-wise normalization factors for the plurality of projects are identified, thereby determining level of quality assurance for performing the software testing. The method and system disclosed herein facilitate efficient handling of fluctuations and software issues occurring during the software testing of the plurality of projects and reduces various managerial and operational overheads during the software testing.

### TECHNICAL FIELD

The present subject matter is related, in general to software testing and more particularly, but not exclusively to a method and system for determining effort tor performing software testing.

### BACKGROUND

Presently, in an organization, numerous software requests are being generated on a regular basis. Multiple teams, having multiple software test professionals, in the organization need to co-ordinate with each other to service/handle the software requests. Also, due to ever-changing market needs, the software test professionals are finding it extremely difficult to keep in pace with business requirements of the organization and to estimate amount of time and efforts required to handle the software requests.

There are various testing models currently being practiced between service providers and customers for handling the ever-Increasing software requests. The existing testing models have limited applicability. Also, the existing testing models face various key challenges since complete ownership over the testing models lies with the customers and, in most cases, an IT support arm must be created for effectively addressing the software requests/issues. However, having an additional IT support arm in the organization would create a diversion from key business requirements of the organization.

For example, a customer operating in a ‘Time & Material’ model may experience various operational overheads due to setting up of the additional IT arm to get the business requirements fulfilled. Further, the organization may suffer overheads due to additional professionals involved, additional process and practice of new technologies. Hence, it is necessary to estimate the efforts involved in handling the software requests and to provide the same to the customers, thereby facilitating the customers to identify basic elements service and to monitor the efforts involved in the entire process.

### SUMMARY

Disclosed herein is a method of determining effort for performing software testing. The method comprises receiving, by an effort determining system, historical effort data of one or more projects. The historical effort data indicates past effort taken during performing one or more phases of Software Development Life Cycle (SDLC) associated with the one or more projects. Also, the method comprises receiving project complexity data of the one or more projects across a set of predefined parameters associated with the one or more projects. The project complexity data comprises one or more sizes, associated with the one or more projects, indicating complexity of the one or more projects. Further, the method computes one or more normalization factors corresponding to the one or more projects based on the one or more sizes of the one or more projects. Upon computing the one or more normalization factors, a set of ratings corresponding to the set of predefined parameters for each of the one or more projects is received from a user. After receiving the set of ratings, the method computes a set of weightages corresponding to the set of predefined parameters based on the set of ratings for each of the one or more projects. Further, one or more complexity scale-wise normalization factors corresponding to die one or more projects are computed by correlating one or more complexity scales corresponding to the one or more projects and the one or more normalization factors. The one or more complexity scales are determined based on the set of ratings and the set of weightages. Finally, one or more Test Unit Points (TUPs) corresponding to the one or more projects are computed based on the one or more sizes and the one or more complexity scale-wise normalization factors. The one or more TUPs indicates level of quality assurance for performing the software testing.

Further, the present disclosure relates to an effort determining system for determining effort for performing software testing. The system comprises a processor and a memory communicatively coupled to the processor. The memory stores processor-executable instructions, which, on execution, causes the processor to receive historical effort data of one or more projects, indicating past effort taken during performing one or more phases of Software Development Life Cycle (SDLC) associated with the one or more projects. Further, the processor receives project complexity data of the one or more projects across a set of predefined parameters associated with the one or more projects. The project complexity data comprises one or more sizes associated with the one or more projects indicating complexity of the one or more projects. Further, the processor computes one or move normalization factors corresponding to the one or more projects based on the one or more sizes of the one or more projects. Upon computing the one or more normalization factors, the processor receives, from a user, a set of rating corresponding to the set of predefined parameters for each of the one or more projects. After receiving the set of rating, the processor computes a set of weightages corresponding to the set of predefined parameters based on the set of ratings for each of the one or more projects. Further the processor computes one or more complexity scale-wise normalization factors corresponding to the one or more projects by correlating one or more complexity scales corresponding to the one or more projects and the one or more normalization factors. The one or more complexity scales are determined based on the set of ratings and the set of weightages. Finally, the processor computes one or more Test Unit Points (TUPs) corresponding to the one or more projects based on the one or more sizes and the one or more complexity scale-wise normalization factors. The one or more TUPs indicates level of quality assurance for performing the software testing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the FIGS., the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for determining effort for performing software-testing in accordance with some embodiments of the present disclosure;

FIG. 2 shows a detailed block diagram illustrating an effort determining system for determining effort for performing software testing in accordance with some embodiments of the present disclosure:

FIG. 3 shows a flowchart illustrating a method for determining effort for performing software testing in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that, any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and an effort determining system for determining the effort required for performing software testing of the one or more products. In an embodiment, the instant method helps an organization to define one or more Test Unit Points (TUP) corresponding to the one or more projects for indicating level of quality assurance for performing the software testing. The TUPs may be considered as an alternative technique for traditional effort estimation techniques. The TUP based model enables implementation of outcome based models, which in turn are capable of accommodating fluctuation in demand and scope across the organization. The TUP based model may also motivate service providers to implement transformative and innovative solutions and bring in sustained competitive advantages into the organization.

In an embodiment, the TUP may be defined by taking various test inputs into consideration. As an example, the TUPs may include various test constructs, such as Test management, Test design and Test execution. The TUPs may be defined based on various complexity across the one or more projects, for example, number of interfaces, technology stack, implementation, language being implemented, reusability and the like.

The method and system of the instant disclosure propose and design solution to the problem as a single unit of measure, a consistent and organization-wide accepted unit. The designed unit is aimed at simplifying the estimation and invoicing process, along with reduced management overhead at a customer end, since complete responsibility of the process is shifted to the service providers. In an embodiment, the TUP based model of the instant disclosure helps in establishing a standard and transparent estimation process across the organization and enables unit level cost predictability for the one or more service/software requests. Also, the instant method helps in managing flexibility in demand fluctuations and provides a consistent and uniform interpretation of the testing work load, enabling a mechanism to monitor and demonstrate Year-on-Year benefits to the organization. Furthermore, the method helps in reducing various overheads on the customers by completely transferring the responsibilities to the service providers, thereby enhancing the client focus on core business requirements of the organization or as required by them.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

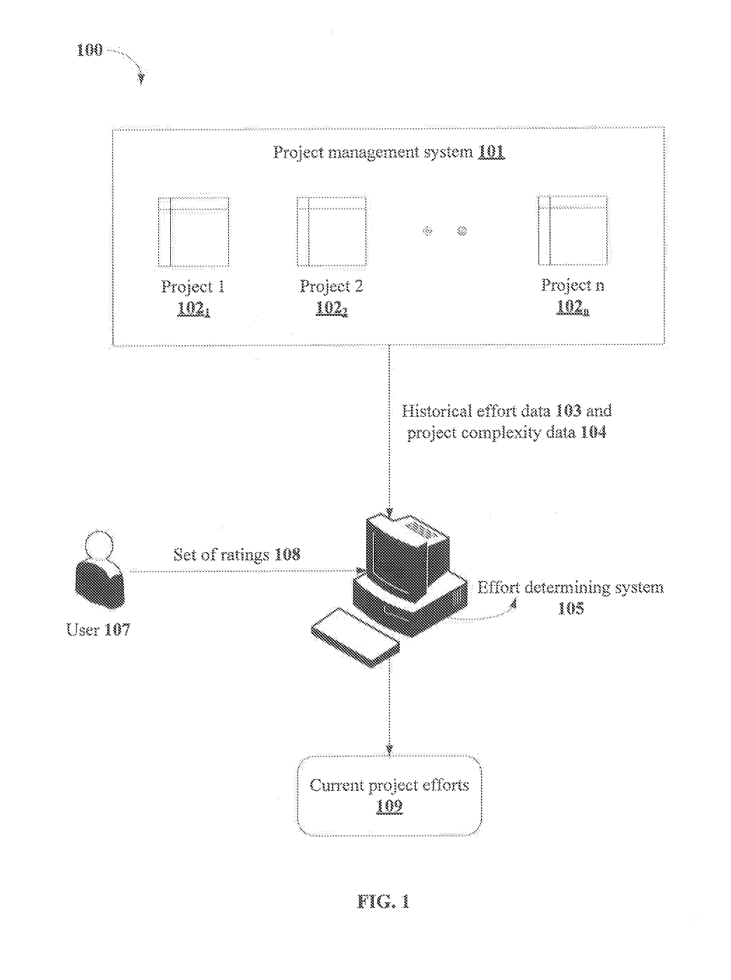

FIG. 1 shows an exemplary environment for determining effort for performing software testing in accordance with some embodiments of the present disclosure.

The environment 100 includes a project management system 101, a user 107 and an effort determining system 105. The project management system 101 may include one or more projects namely, project 1 102₁; to project n 102ₙ (collectively referred as one or more projects 102). The one or more projects 102 may be identified based on maturity and complexity of the one or more projects 102. In an embodiment, the project management system 101 may include a demand management system (not show in FIG. 1), which is a planning and storage tool used to forecast, plan and manage demands and efforts required for the one or more projects 102. As an example, the project management system 101 may be at least one of, without limiting to, Microsoft Project, Jira, E-cube and the like.

In an embodiment, the effort determining system 105 interfaces with the project management system 101 to receive historical effort data 103 of each of the one or more projects 102 based on data captured during performing one or more phases of Software Development Life Cycle (SDLC) of the one or more projects 102 in the past. Also, along with the historical effort data 103, the effort determining system 105 receives project complexity data 104 of the one or more projects 102 across a set of predefined parameters 211 associated with the one or more projects 102. As an example, the set of predefined parameters 211 may include, without limiting to, number of third party interfaces, one or more skills, one or more technologies, one or more computing platforms, number of impacting modules associated with the one or more projects 102, reusability percentage of test cases, automation percentage of test cases, and requirement percentage volatility.

In an embodiment the historical effort data 103 may include one or more sizes associated with the one or more projects 102. Each size of the historical effort data 103 may indicate level of complexity of the one or more projects 102. As an example, the one or more sizes of complexity may be small, medium, large or extra-large. In an embodiment, the effort determining system 105 uses the historical effort data 103 and the project complexity data 104 for computing one or more normalization factors corresponding to the one or more projects 102.

In an embodiment, upon receiving the historical effort data 103 and the project complexity data 104, the effort determining system 105 may receive a set of ratings 108 corresponding to the set of predefined parameters 211 for each of the one or more projects 102. As an example, the user 107 may be a customer, may be a vendor or a software professional who is involved in software testing of the one or more projects 102. Further, the effort determining system 105 may compute a set of weightages corresponding to the set of predefined parameters 211 for each of the one or more projects 102 based on the set of ratings 108. The set of ratings 108 and the set of weightages of each of the one or more projects 102 may be used to determine one or more complexity scales corresponding to the one or more projects 102. Subsequently, the one or more complexity scales data may be used to compute one or more complexity scale-wise normalization factors corresponding to the one or more projects 102 by correlating the one or more complexity scales with the one or more normalization factors.

In an embodiment, the one or more sizes and the one or more complexity scale-wise normalization factors may be used to compute one or more Test Unit Points (TUPs) corresponding to the one or more projects 102. The one or more TUPs may indicate a level of quality assurance required for performing the software testing of the one or more projects 102. Finally, the effort determining system 105 uses the one or more TUPs to determine one or more current project efforts 109 required for testing the one or more projects 102.

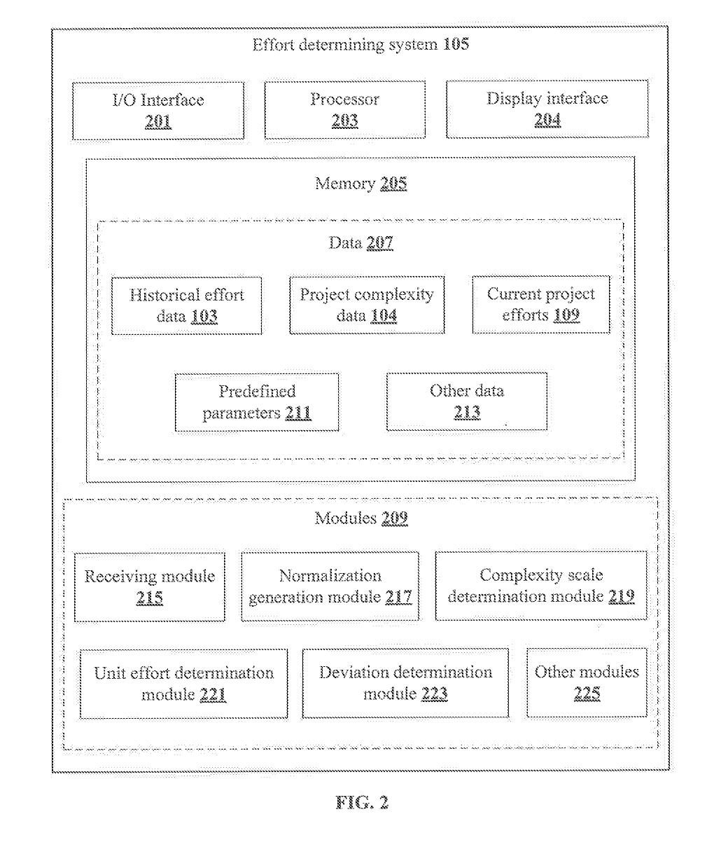

FIG. 2 shows a detailed block diagram illustrating an effort determining system 105 for determining effort for performing software testing in accordance with some embodiments of the present disclosure.

The effort determining system 105 includes an I/O interface 201, a processor 203, a display interface 204 and a memory 205. The I/O interface 201 may be configured to receive the historical effort data 103 and the project complexity data 104 of the one or more projects 102 from the project management system 101. Also, the I/O interface 201 may be used to communicate with the user 107 to collect the set of ratings 108 corresponding to the set of predefined parameters 211, tor the one or more projects 102. In an implementation, the display interface 204 may be external to the effort determining system 105. The memory 205 may be communicatively coupled to the processor 203. The processor 203 may be configured to perform one or more functions of the effort determining system 105 for determining the effort for performing the software testing. In one implementation, the effort determining system 105 may include data 207 and modules 209 for performing various operations in accordance with the embodiments of the present disclosure. In an embodiment, the data 207 may be stored within the memory 205 and may include, without limiting to, historical effort data 103, project complexity data 104, current project efforts 109, predefined parameters 211 and other data 213.

In an embodiment, the display interface 204 may be used for indicating one or more complexity scale-wise normalization factors and level of quality assurance required for performing the software testing of the one or more projects 102. Further, using the display interface 204, the user may provide multiple inputs, including the set of ratings 108 for each of the one or more projects 102 based on complexity level of each of the one or more projects 102. Also, the display interface 204 may facilitate the user 107 to rank the set of predefined parameters 211 and to provide a set of weightages corresponding to the set of predefined parameters 211 as a part of computation of one or more complexity scale-wise normalization factors. In an embodiment, in addition to performing the above functionalities, the display interface 204 may be used by the user 107 for adding a new parameter or for deleting an existing parameter from the set of predefined parameters 211.

In some embodiments, the data 207 may be stored within the memory 205 in the form of various data structures. Additionally, the data 207 may be organized using data models, such as relational or hierarchical data models. The other data 213 may store data, including temporary data and temporary files, generated by the modules 209 for performing the various functions of the effort determining system 105.

In an embodiment, the historical effort data 103 of the one or more projects 102 indicates past efforts taken during performing the one or more phases of SDLC for the one or more projects 102. The historical effort data 103 may include data related to a series of steps to be followed during design and development of each of the one or more projects 102, starting from requirement analysis phase until the one or more projects 102 are successfully executed.

In an embodiment, the project complexity data 104 of the one or more projects 102 may be collected across the set of predefined parameters 211 associated with the one or more projects 102 for gauging the level of complexity of the one or more projects 102. In an implementation, both the historical effort data 103 and the project complexity data 104 may be collected from the project management system 101 and the demand management system associated with the effort determining system 105.

In an embodiment, the one or more current project efforts 109 indicate the amount of efforts required for performing the software testing of the one or more projects 102. The one or more current project efforts 109 may be determined using the one or more TUPs corresponding to the one or more projects 102.

In an embodiment, the set of predefined parameters 211 are associated with the one or more projects 102 and are used to determine the project complexity data 104 of the one or more projects 102. Further, the predefined parameters may be used for computing the set of weightages based on the set of ratings 108 provided for each of the one or more products. In an embodiment, the user 107 may dynamically modify the set of predefined parameters 211 by adding a new parameter or by deleting an existing parameter from the set of predefined parameters 211 depending on the nature of the one or more projects 102. In an example, the set of predefined parameters 211 may include following parameters:

Number of third-party interlaces:

The number of third-party interlaces indicates a count of one or more upstream and downstream interfaces that the one or more projects 102 are connected to.

Skills:

The one or more skills or ‘Niche skills’ indicates list of specialized resource skills that the one or more projects 102 demand. For example, data centric testing and performance testing are two of the skills required for comprehensively testing the one or more projects 102.

Technologies:

A list of one or more technologies being used in the one or more projects 102 is a significant parameter for determining the complexity level of the one or more projects 102. For instance, the one or more technologies that may be used in the one or more projects 102 may be Java, .Net, XML and the like.

Computing Platform:

The one or more technologies being used in the one or more projects 102 is also a significant parameter required for determining the nature and complexity level of the one or more projects 102. As an example, the one or more projects 102 may be based on Web interface, Mainframe interface and the similar.

Number of impacting modules:

Number of impacting modules in the one or more projects 102 indicates a count of the number of modules that are impacted directly or indirectly due to changes in one or more parts of the current project.

Reusability Percentage:

Reusability percentage is the percentage of existing test cases that are being re-used during test execution of the one or more projects 102 in response to the changes in the one or more parts of the current project. As an example, the one or more test cases related to the one or more projects 102 may be stored in a test repository associated with the one or more projects 102.

Automation percentage:

Automation percentage indicates the percentage of test cases in the test repository that have been automated.

Requirement percentage volatility:

The requirement percentage volatility indicates the percentage of requirement factors that were changed during the development of the one or more projects 102.

In some embodiments, the data 207 may be processed by one or more modules 209 of the effort determining system 105. In one implementation, the one or more modules 209 may be stored as a part of the processor 203. In another implementation, the one or more modules 209 may be communicatively coupled to the processor 203 for performing one or more functions of the effort determining system 105. The modules 209 may include, without limiting to, a receiving module 215, a normalization generation module 217, a complexity scale determination module 219, a deviation determination module 223, a unit effort determination module 221 and other modules 225.

As used herein, the term ‘module’ refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 225 may be used to perform various miscellaneous functionalities of the effort determining system 105. It will be appreciated that such modules 209 may be represented as a single module or a combination of different modules.

In some embodiments, the receiving module 215 may be responsible for receiving the historical effort data 103 and the project complexity data 104 corresponding to the one or more projects 102 from the project management system 101. Further, the receiving module 215, using the display interface 204, may receive the set of ratings 108 corresponding to the set of predefined parameters 211 for each of the one or more projects 102. In an implementation, the receiving module 215 and the project management module may be interfaced using a web service based interface, where the historical effort data 103 and the project complexity data 104 are retrieved through the web interface.

In an embodiment, the normalization generation module 217 may be responsible for computing the one or more normalization factors corresponding to the one or more projects 102 based on the one or more sizes of the one or more projects 102. In an implementation, the normalization generation module 217 may utilize a code-based logic to generate the one or more normalization factors across the one or more projects 102. The code-based logic may include an Application Programming interface (API) and one or more database connectivity protocols, such as Open Database Connectivity (ODBC) or Java Database Connectivity (JDBC).

In an embodiment, the normalization generation module 217 analyzes individual efforts associated with the each of the one or more projects 102 and determines the total efforts required for each of the one or more projects 102 as a sum of the individual efforts. Further, based on the size of the one or more projects 102, the normalization generation module 217 computes the effort required per unit size of the one or more projects 102 by using the equation (1) below.

i.e. Effort per unit=(Total efforts required across the one or more projects)/(The input size of the one or more projects) (1)

As an example, if there are three input sizes namely, ‘Small’, ‘Medium’ and ‘Complex’, then, the total efforts may be determined by dividing all three input sizes by the effort value per unit size of a predefined simple input size, i.e., if the simple input size is ‘Short’, then the total efforts may be calculated by normalizing each of the three input sizes with respect to the Input size ‘Short’ and then summing up each of the normalized values.

Further, the normalization generation module 217 may calculate distribution of input sizes across each of the one or more projects 102 by taking a ratio of the input sizes of all the complexities in the one or more projects 102. As an example, if there are 100 requirements in a project, among which, 30 requirements are small sized, 20 requirements are medium sized and 50 requirements are large sized, then the ratio of input distribution would be 20%: 30%: 50%. Subsequently, the normalization generation module 217 computes the one or more normalization factors across each of the one or more projects 102 by taking an average of the distribution of the input sizes and reaching at a final value.

In an embodiment, the complexity scale determination module 219 may be responsible for computing the one or more complexity scale-wise normalization factors corresponding to the one or more projects 102 by correlating the one or more complexity scales corresponding to the one or more projects 102 and the one or more normalization factors. Initially, the complexity scale determination module 219 identifies the project complexity data 104 for each of the one or more projects 102 across the set of predefined parameters 211.

In an implementation, the user 107 may directly assign the project complexity data 104 for the one or more projects 102 using the display interface 204. The complexity scale determination module 219, through the display interface 204, may provide a dropdown option, indicating various parameter scale values against each predefined parameter in the set of predefined parameters 211. The user 107 may select one of the parameter scale values provided in the dropdown option to reflect the complexity of the parameters. As an example, the parameter scale values may be in a range of 1 to 5, where selecting a value ‘1’ indicates that the one or more projects 102 are least complex; and selecting a value ‘5’ indicates that the one or more projects 102 are most complex. In an embodiment, receiving the project complexity data 104 from the user 107 may be a one-time activity during the determination of the effort required for performing the integration testing of the one or more projects 102. Table A represents exemplary correlation between the complexity scale associated with the one or more projects 102 and a range of weightages that may be assigned to each parameter in the predefined parameters 211.

TABLE A

| Predefined | Complexity Scale | | | | |
|---|---|---|---|---|---|
| parameters | 1 | 2 | 3 | 4 | 5 |
| No. of third-party | >=0 and <2 | >=2 and <4 | >=4 and <7 | >=7 and <10 | >=10 |
| interfaces | | | | | |
| Skills | Microsoft | Data Testing/ | Open | Performance | TIBCO |
| | Tools/SQL | Automation | Source | Testing/ | |
| | | Tools | Tools | TOSCA | |
| Technology | Java/.Net/ | Open | Oracle/C++/ | TIBCO/ | Power- |
| | XML | Road | Sybase | COBOL | Builder |
| Computing | Web Services/ | Oracle/Unix/ | Mainframe | SAP | Ingres DB |
| platform | Windows | Sybase | | | |
| No. of impacting | >=0 and <2 | >=2 and <6 | >=6 and <10 | >=10 and <15 | >=15 |
| modules | | | | | |
| Percentage of | >=60 | >=45 and <60 | >=30 and <45 | >=15 and <30 | >0 and <15 |
| Reusability | | | | | |
| Percentage of | >=80 and <=100 | >=60 and <80 | >=40 and <60 | >=20 and <40 | >0 and <20 |
| Automation | | | | | |
| Percentage of | 0> and >5 | >=5 and <10 | >=10 and <25 | >=25 and <50 | >=50 |
| requirement | | | | | |
| volatility | | | | | |

Further, the complexity scale determination module 219 may compute the set of weightages corresponding to the one or more projects 102 across each predefined parameter in the set of predefined parameter. The set of weightages may be decided based on importance of each predefined parameter in the set of predefined parameters 211. In an embodiment, the complexity scale determination module 219, through the display interface 204, may receive a user-defined rank for each parameter in the set of predefined parameters 211 from the user 107, As an example, if there are 8 parameters in the set of predefined parameters 211, then the ranking provided by the user 107 would be in the range of 1 to 8. Also, the set of weightages of each parameter in the set of predefined parameters 211 would be proportionate to the ranking provided to each parameter in the set predefined parameters 211. However, if the user 107 does not provide any rank to the set of predefined parameters 211, then the complexity scale determination module 219 may assign an equal weightage for each parameter in the set of predefined parameters 211.

In an exemplary scenario, based on the importance of the set of predefined parameters 211 in the one or more projects 102, the user 107 may provide ranking to each parameter in the set of predefined parameters 211 as shown in Table B. Now, based on the rankings provided to each parameter in the set of predefined parameters 211, a set of weightages, which are proportional to the rankings, is assigned to each parameter in the set of predefined parameters 211 as shown in Table B.

TABLE B

| Predefined | | Weightage |
|---|---|---|
| parameters | Rank | (in %) |
| No. of third-party | 5 | 14 |
| interfaces | | |
| Skills | 2 | 6 |
| Technology | 4 | 11 |
| Computing platform | 6 | 17 |
| No. of impacting | 3 | 8 |
| modules | | |
| Percentage of | 7 | 19 |
| Reusability | | |
| Percentage of | 8 | 22 |
| Automation | | |
| Percentage of | 1 | 3 |
| requirement | | |
| volatility | | |

Finally, the complexity scale determination module 219 may compute the overall complexity in performing the software testing of the one or more projects 102 based on the set of weightages and the complexity scale corresponding to each of the one or more projects 102. The computation of overall complexity of the one or more projects 102 is represented in Table C below.

In an embodiment, the unit effort determination module 221 may be responsible for computing the one or snore TUPs corresponding to the one or more projects 102 based on the one or more sizes and the one or more complexity scale-wise normalization factors associated with the one or more projects 102. The one or more TUPs may indicates a level of quality assurance required for performing the software testing of the one or more projects 102. In an embodiment, the one or more TUPs may be computed by leveraging a product of the one or more input sizes and the complexity scale-wise normalization factors associated with the one or more projects 102 based on overall complexity of the one or more projects 102.

Further, the amount of effort required per unit size of the one or more projects 102 may be computed using the actual project efforts and the one or more TUPs across the one or more projects 102 as indicated in equation (2) below.

i.e. Effort per unit=Actual project efforts/TUPs in the project (2)

Subsequently, the unit effort determination module 221 computes an average effort per unit across the one or more projects 102. Further, the overall cost of service of the one or more projects 102 may be evaluated based on rate of resource usage by the one or more projects 102 and the average of the effort per unit across the one or more projects 102, as indicated in equation (3).

i.e. Cost of service per unit=Cost of resource*Average effort per unit (3)

The cost of service may signify the amount of money that would be required for handling the one or more TUPs for the service type requested.

In an embodiment, the deviation determination module 223 may be responsible for determining a deviation in effort by comparing the one or more current projects effort 109 with one or more actual project efforts. The one or more actual project efforts may be determined from the historical effort data 103. Initially, the deviation determination module 223 compute the effort per TUP based on the average effort per unit across the one or more projects 192 and the TUPs for the one or more projects 102 as shown in equation (4).

i.e. Effort per TUP=TUPs for the project*Average efforts per unit (4)

Further, the deviation in effort may be calculated using the actual project efforts and the effort per TUP. Also, a percentage of deviation in efforts is calculated (equation 5) for each of the one or more projects 102 to understand difference between the efforts per TUP and the actual project efforts.

Percentage of deviation in effort=(Effort per TUP−Actual project efforts)/Overall efforts*100 (5)

In an embodiment, the value of deviation in efforts may indicate whether the deviation is negative or positive.

Finally, the effort determining system 105 also includes measuring accuracy of the calculation of efforts per TUPs. In an embodiment if the deviation in efforts is within the acceptable range (>=95%), then the user 107 (say, a project manager) could accept the TUPs. On the other hand, if the deviation does not comply with an acceptable range, then the user 107 may give feedbacks, suggesting one or more changes to be made in the model. The one or more changes suggested by the user 107 can be incorporated and the model can be redefined to implement all the requirements. The redefinition of the model would be carried out until the deviation in efforts falls under the desired acceptable range. In an embodiment, upon completing the accuracy measurement, the effort determining system 105 may display the one or more TUPs to the user 107 through the display interface 204. Once the user 107 accepts the displayed TUP model, one or more on-the-spot estimates may be generated and provided for any new service request raised by the user 107, based on the significance or complexity scale assigned for each parameter in the set of predefined parameters 211.

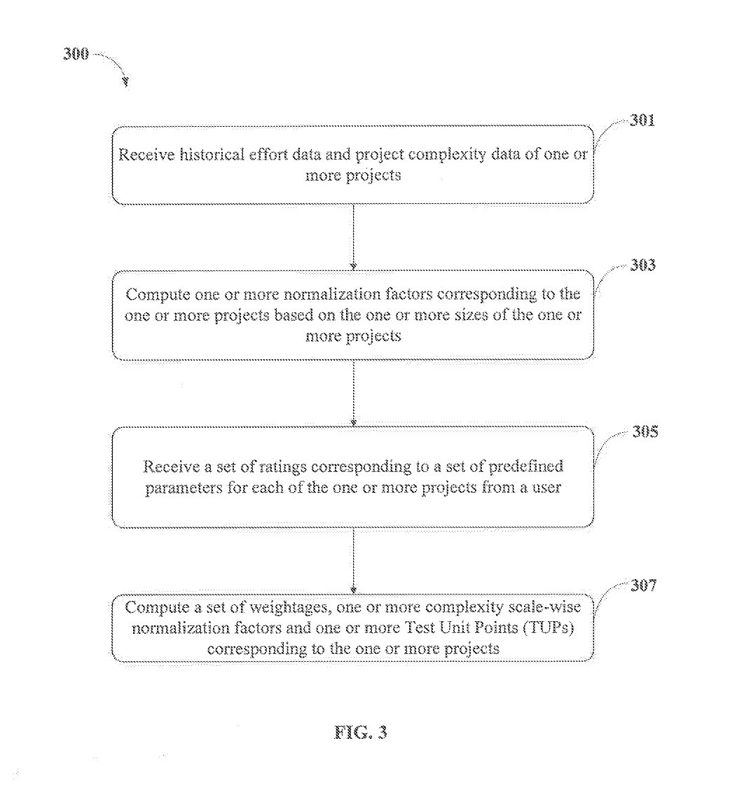

FIG. 3 shows a flowchart illustrating a method for determining effort for performing software testing in accordance with some embodiments of the present disclosure.

As illustrated in FIG. 3, the method 308 includes one or more blocks illustrating a method of determining effort for performing software testing using an effort determining system 105. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method 300 includes receiving, by the effort determining system 105, historical effort data 103 of one or more projects 102. The historical effort data 163 may indicate past effort taken during performing one or more phases of Software Development Life Cycle (SDLC) associated with the one or more projects 102. In an embodiment, the one or more projects 102 may be selected from a plurality of projects 102 based on maturity of the one or more projects 102. As an example, the maturity may be determined based on receiving user 107 input in response to a set of predefined factors. For instance, the set of predefined factors to gauge the maturity of the one or more projects 105 may include, without limiting to, duration since the project has been live, effort data collection of the project for at least 3-4 months, level of automation, reporting methodology and the like.

Further, the block 301 includes receiving project complexity data 104 of the one or more projects 102 across a set of predefined parameters 211 associated with the one or more projects 102. As an example, the project complexity data 104 may include, without limiting to, one or more sizes associated with the one or more projects 102. The one or more sizes may indicate complexity of the one or more projects 102.

At block 303, the method 300 includes computing, by the effort determining system 105, one or more normalization factors corresponding to the one or more projects 102 based on the one or more sizes of the one or more projects 102. As an example, the one or more sizes of the one or more projects 102 may be categorized into at least one of small, medium, large, and extra-large category.

At block 305, the method 300 includes receiving, by the effort determining system 105, a set of ratings 108 corresponding to the set of predefined parameters 211 for each of the one or more projects 102. As an example, the set of predefined parameters 211 may include at least one of number of third party interfaces, one or more skills, one or more technologies, one or more computing platforms, number of impacting modules associated with the one or more projects 102, reusability percentage of test cases, automation percentage of test cases, and requirement percentage volatility. In an embodiment, the effort determining system 105 may enable the user 107 to dynamically change the set of predefined parameters 211.

At block 307, the method 300 includes computing, by the effort determining system 105, a set of weightages corresponding to the set of predefined parameters 211 based on the set of ratings 108 for each of the one or more projects 102. Further, one or more complexity scale-wise normalization factors corresponding to the one or more projects 102 may be computed by correlating one or more complexity scales corresponding to the one or more projects 102 and the one or more normalization factors. Here, the one or more complexity scales may be determined based on the set of ratings 108 and the set of weightages. Upon computing the one or more complexity scale-wise normalization factors, the block 307 further includes computing one or more Test Unit Points (TUPs) corresponding to the one or more projects 102 based on the one or more sizes and the one or more complexity scale-wise normalization factors. As an example, the one or more TUPs indicates level of quality assurance for performing the software testing.

In an embodiment, the effort determining system 105 may further include determining one or more current project efforts 109 using the one or more TUPs corresponding to the one or more projects 102. Also, the effort determining system 105 may determine a deviation in effort by comparing the one or more current project efforts 109 with one or more actual project efforts. As an example, the one or more actual project efforts may be determined from the historical effort data 103.

Computer System

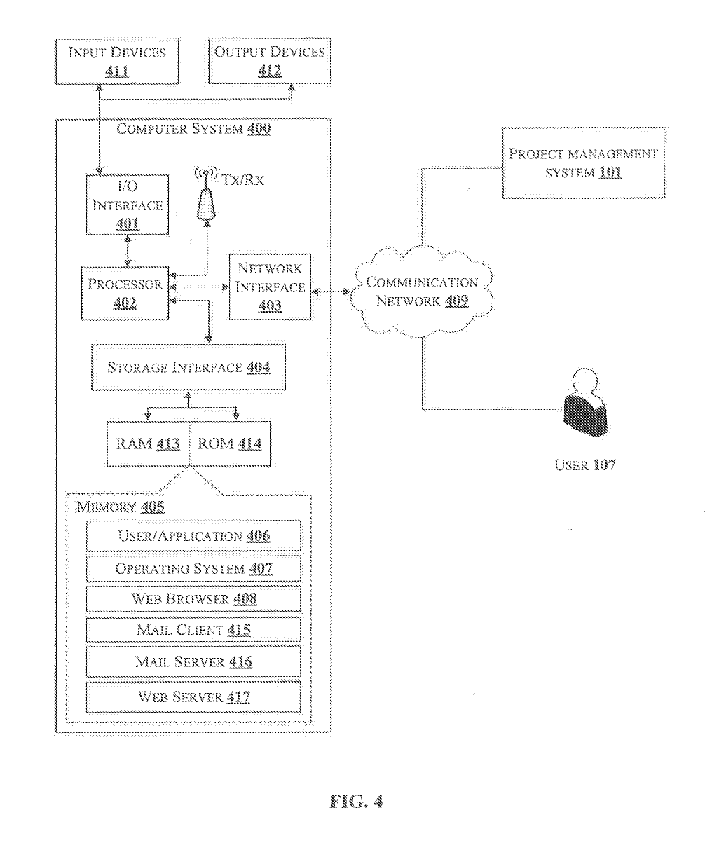

FIG. 4 illustrates a block diagram of an exemplary computer system 400 for implementing embodiments consistent with the present disclosure. In an embodiment, the computer system 400 may be the effort determining system 185 which is used for determining the effort for performing software testing. The computer system 400 may include a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The 170 interface 401 may employ communication protocols/methods such as, without limitation, audio, analog, digital, stereo, IEEE-1394, serial bus, Universal Serial Bus (USB), infrared, PS/2, BNC, coaxial, component composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412). In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11 a/b/g/n/x, etc. Using the network interface 403 and the communication network 409, the computer system 400 may communicate with a project management system 101 for receiving historical effort data 183 and project complexity data 104 associated with the one or more projects 102. Further, the communication network 409 may be used to communicate with a user 107 of the effort determining system 105 for receiving a set of ratings 108 corresponding to a set of predefined parameters 211 for each of the one or more projects 102. The communication network 409 can be implemented as one of the different, types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 482 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive. Redundant Array of Independent Discs (RAID), solid-state memory devices, solid-state drives, etc.

The memory 405 may store a collection of program or database components, including, without limitation, user/application 406, an operating system 407, web browser 408 etc. In some embodiments, computer system 400 may store user/application data 406, such as the data, variables, records, etc. as described in this invention. Such databases may be implemented as limit-tolerant, relational, scalable, secure databases such as Oracle or Sybase.

The operating system 407 may facilitate resource management and operation of the computer system 400, Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XF, Vista/7/8, etc.), Apple iOS, Google Android, Blackberry Operating System (OS), or the like, A user interface may facilitate display, execution, interaction, manipulation, or operation of program components through textual or graphical facilities. For example, user interlaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows web interface libraries (e.g., ActiveX, Java, JavaScript, AJAX, HTML, Adobe Flash, etc.), or the like,

In some embodiments, the computer system 400 may implement a web browser 408. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interlaces (APIs), etc. In some embodiments, the computer system 400 may implement a mail server stored program component. The mail server 416 may be an Internet mail server such as Microsoft Exchange, or the like. The mail server 416 may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client 415. The mail client 415 may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method for determining the efforts required for performing software testing of the one or more projects.

In an embodiment, the method of the present disclosure provides a standardized, transparent and productive estimation process for the one or more projects.

In an embodiment, the method of the present disclosure provides an efficient, model to handle the demand fluctuations and the service requests from the one or more projects.

In an embodiment, the method of the present disclosure helps in reducing the management overheads and increases client focus on core business principles and requirements of an organization.

In an embodiment, the method of the present disclosure provides a consistent and uniform interpretation of the software requests, thereby enabling a mechanism to monitor and demonstrate the Year-on-Year benefits to the organization.

In an embodiment, the method of present disclosure provides agility to adopt to any Software Development Life Cycle (SDLC) methodology associated with the one or more projects.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Project management system |
| 102 | Projects |
| 103 | Historical effort data |
| 104 | Project complexity data |
| 105 | Effort determining system |
| 107 | User |
| 108 | Set of ratings |
| 109 | Current project efforts |
| 201 | I/O Interface |
| 203 | Processor |
| 204 | Display interface |
| 205 | Memory |
| 207 | Data |
| 209 | Modules |
| 211 | Predefined parameters |
| 213 | Other data |
| 215 | Receiving module |
| 217 | Normalization |
| | generation module |
| 219 | Complexity scale |
| | determination module |
| 220 | Unit effort determination |
| | module |
| 223 | Deviation determination |
| | module |
| 225 | Other modules |

What is claimed is:

1. A method of determining effort for performing software testing, the method comprising:
receiving, by an effort determining system (105),
historical effort data (103), of one or more projects (102), indicating past effort taken during performing one or more phases of Software Development Life Cycle (SDLC) associated with the one or more projects (102), and
project complexity data (104) of the one or more projects (102) across a set of predefined parameters (211) associated with the one or more projects (102), wherein the project complexity data (104) comprises one or more sizes, associated with the one or more projects (102), indicating complexity of the one or more projects (102):
computing, by the effort determining system (105), one or more normalization factors corresponding to the one or more projects (102) based on the one or snore sizes of the one or more projects (102);
receiving, by the effort determining system (105), from a user (107), a set of ratings (108) corresponding to the set of predefined parameters (211) for each of the one or more projects (102); and
computing, by the effort determining system (105),
a set of weightages corresponding to the set of predefined parameters (211), based on the set of ratings (108), for each of the one or more projects (102),
one or more complexity scale-wise normalization factors corresponding to the one or more projects (102) by correlating one or more complexity scales corresponding to the one or more projects (102) and the one or more normalization factors, wherein the one or more complexity scales are determined based on the set of ratings (108) and the set of weightages, and
one or more Test Unit Points (TUPs) corresponding to the one or more projects (102) based on the one or more sizes and the one or more complexity scale-wise normalization factors, wherein the one or more TUPs indicates level of quality assurance for performing the software testing.

2. The method as claimed in claim 1, further comprising determining one or more current project efforts (109), using the one or more TUPs, corresponding to the one or more projects (102).

3. The method as claimed in claim 1, further comprising determining a deviation in effort by comparing the one or more current project efforts (109) with one or more actual project efforts, wherein the one or more actual project efforts are determined from the historical effort data (103).

4. The method as claimed in claim 1, wherein the one or more projects (102) are selected, from a plurality of projects, based on maturity of the one or more projects (102), wherein the maturity is determined based on receiving user (107) input in response to a set of predefined factors.

5. The method as claimed in claim 1, wherein the one or more sizes, of the one or more projects (102), is categorized into at least one of small, medium, large, and extra-large category.

6. The method as claimed in claim 1, wherein the set of predefined parameters (211) comprises at least one of number of third party interfaces, one or more skills, one or more technologies, one or more computing platforms, number of impacting modules associated with the one or more projects (102), reusability percentage of test cases, automation percentage of test cases, and requirement percentage volatility.

7. The method as claimed in claim 1, further comprising enabling the user (107) to dynamically change the set of predefined parameters (211).

8. An effort determining system (105) for determining effort for performing software testing, the system comprising:
a processor (203); and
a memory communicatively coupled to the processor (203), wherein the memory stores processor-executable instructions, which, on execution, causes the processor (203) to:
receive, historical effort data (103), of one or more projects (102), indicating past effort taken during performing one or more phases of Software Development Life Cycle (SDLC) associated with the one or more projects (102),
and project complexity data (104) of the one or more projects (102) across a set of predefined parameters (211) associated with the one or more projects (102), wherein the project complexity data (104) comprises one or more sizes, associated with the one or more projects (102), indicating complexity of the one or more projects (102);
compute one or more normalization factors corresponding to the one or more projects (102) based on the one or more sizes of the one or more projects (102);
receive, from a user (107), a set of ratings (108) corresponding to the set of predefined parameters (211) for each of the one or more projects (102); and
compute, a set of weightages corresponding to the set of predefined parameters (211), based on the set of ratings (108), for each of the one or more projects (102),
one or more complexity scale-wise normalization factors corresponding to the one or more projects (102) by correlating one or more complexity scales corresponding to the one or more projects (102) and the one or more normalization factors, wherein the one or more complexity scales are determined based on the set of ratings (108) and the set of weightages, and
one or more Test Unit Points (TUPs) corresponding to the one or more projects (102) based on the one or more sizes and the one or more complexity scale-wise normalization factors, wherein the one or more TUPs indicates level of quality assurance for performing the software testing.

9. The effort determining system (105) as claimed in claim 8, wherein the processor (203) is further configured to determine one or more current project efforts (109), using the one or more TUPs, corresponding to the one or more projects (102).

10. The effort determining system (105) as claimed in claim 8, wherein the processor (203) is further configured to determine a deviation in effort by comparing the one or more current project efforts (109) with one or more actual project efforts, wherein the one or more actual project efforts are determined from the historical effort data (103).

11. The effort determining system (105) as claimed in claim 8, wherein the one or more projects (102) are selected, from a plurality of projects (102), based on maturity of the one or more projects (102), wherein the maturity is determined based on receiving user (107) input in response to a set of predefined factors.

12. The effort determining system (105) as claimed in claim 8, wherein the one or more sizes, of the one or more projects (102), is categorized into at least one of small, medium, large, and extra-large category.

13. The effort determining system (105) as claimed in claim 8, wherein the set of predefined parameters (211) comprises at least one of number of third party interfaces, one or more skills, one or more technologies, one or more computing platforms, number of impacting modules associated with the one or more projects (102), reusability percentage of test cases, automation percentage of test cases, and requirement percentage volatility.

14. The effort determining system (105) as claimed in claim 8, wherein the processor (203) is further configured to enable the user (107) to dynamically change the set of predefined parameters (211).
